(19) United States
(12) Patent Application Publication
(10) Pub. No.: US 2013/0315527 A1
(43) Pub. Date: Nov. 28, 2013

(54) PHOTOCARRIER-INJECTING VARIABLE OPTICAL ATTENUATOR

(71) Applicants: Xiaochen Sun, Pomona, CA (US); Ningning Feng, Arcadia, CA (US); Dawei Zheng, Irvine, CA (US)

(72) Inventors: Xiaochen Sun, Pomona, CA (US); Ningning Feng, Arcadia, CA (US); Dawei Zheng, Irvine, CA (US)

(21) Appl. No.: 13/481,293

(22) Filed: May 25, 2012

(51) Int. Cl. G02B 6/12

(52) U.S. Cl. CPC G02B 6/12
USPC 385/14; 156/157

(57) ABSTRACT

A photocarrier-injecting variable optical attenuator that operates by injecting photocarriers into a light transmitting waveguide from a second, injection light source. The light transmitting waveguide may be defined by a ridge extending from a slab of a light transmitting medium. The light transmitting waveguide is transparent to signal light. Light emitted from the second, injection light source is optically absorbed by the light transmitting waveguide to introduce photocarriers in a plurality of configurations, thereby attenuating the signal light.

### FIELD OF THE INVENTION

The invention relates generally to optical devices, and more particularly, to photocarrier-injecting variable optical attenuators.

### BACKGROUND OF THE INVENTION

The following description includes information that may be useful in understanding the present invention. It is not an admission that any of the information provided herein is prior art or relevant to the presently claimed invention, or that any publication specifically or implicitly referenced is prior art.

Optical attenuators are used to reduce the intensity of light signals. These attenuators can employ optical waveguides to confine light signals to particular regions. An optical waveguide is generally defined by a channel or a ridge extending from a slab of a light transmitting medium. Optical attenuators associated with optical waveguides often achieve light signal attenuation by free carrier absorption. Existing practice employs a diode structure to inject free carriers electrically from at least two electrodes in forward bias condition. The concentration of free carriers by the electrical injection method is limited by diode injection efficiency, whereas high operating power and long device lengths are often required to achieve considerable attenuation.

### BRIEF DESCRIPTION OF THE DRAWINGS

Exemplary embodiments are illustrated in the referenced figures. It is intended that the embodiments and figures disclosed herein are to be considered illustrative rather than restrictive.

FIG. 1A is a trimetric view of a photocarrier-injecting optical attenuator according to a first embodiment that includes an optical waveguide for passing light signal and a surface-emitting light source flip-bonded on top of the waveguide for injecting photocarriers in the waveguide.

FIG. 1B is a cross-sectional view of the optical attenuator shown in FIG. 1A taken along the line labeled 1B-1B.

FIG. 2A is a trimetric view of a photocarrier-injecting optical attenuator according to a second embodiment that includes the same optical waveguide and surface-emitting light source as the embodiment shown in FIG. 1A, and further includes an angled mirror structure to enhance light absorption for a light source with larger aperture.

FIG. 2B is a cross section view of the optical attenuator shown in FIG. 2A taken along the line labeled 2B-2B.

FIG. 3 is a trimetric view of a photocarrier-injecting optical attenuator according to a third embodiment that includes an optical waveguide for passing light signals and for absorbing injection light, wherein the signal light and injection light are coupled from two optical fibers into one fiber before entering the waveguide.

FIG. 4A is a trimetric view of a photocarrier-injecting optical attenuator according to a fourth embodiment that includes an optical waveguide for passing light signals and a second, injection waveguide for passing injection light, wherein the injection light is originated from a laser chip that is attached to the chip of the attenuator and is coupled into the injection light waveguide.

FIG. 4B is a top view of the optical attenuator shown in FIG. 4A.

FIG. 5A is a trimetric view of a photocarrier-injecting optical attenuator according to a fifth embodiment that includes an optical waveguide for passing light signals and a second, injection waveguide crossing the first waveguide for introducing injection light thereto, wherein injection light is originated from a laser chip that is attached to the chip of the attenuator and is coupled into the injection light waveguide.

FIG. 5B is a top view of the optical attenuator shown in FIG. 5A.

### DESCRIPTION OF THE INVENTION

One skilled in the art will recognize many methods, systems, and materials similar or equivalent to those described herein, which could be used in the practice of the present invention. Indeed, the present invention is in no way limited to the methods, systems, and materials described.

Embodiments of the present invention are directed to systems and methods for attenuating optical signals by providing a photocarrier-injecting variable optical attenuator. In general, the optical attenuators of the present invention operate by injecting photocarriers into a light transmitting waveguide from a second, injection light source. In some embodiments, the light transmitting waveguide is defined by a ridge extending from a slab of a light transmitting medium. The optical attenuators generally include the second light source, wherein light emitted therefrom is optically absorbed by the waveguide medium to introduce photocarriers in a plurality of configurations.

The injected photocarriers are a form of free carriers, which provide optical absorption of the signal light in the originally transparent waveguide. The optical absorption thus provides optical attenuation of the signal light. The second light source, which provides light that is absorbed by the waveguide, may include, but is not limited to, lasers, light emitting diodes, thermal emitters, etc. The optical energy of the second or injection light source is partially or completely absorbed by the light transmitting waveguide medium, thereby providing the optical attenuation.

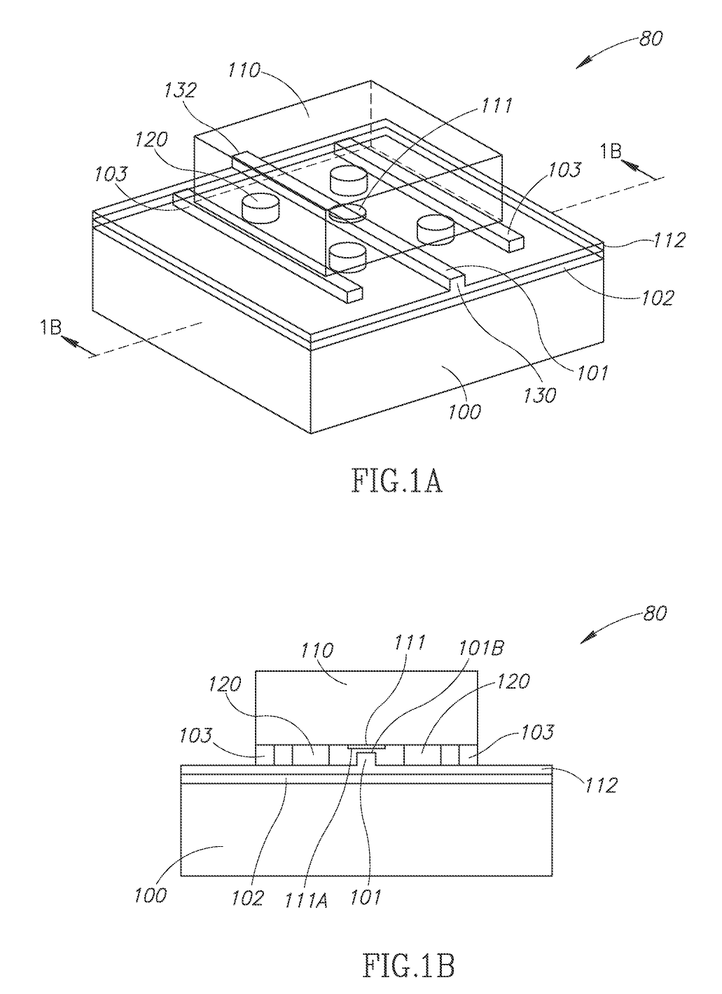

FIG. 1A is a trimetric view of an optical attenuator 80 according to a first embodiment. FIG. 1B is a cross-sectional view of the optical attenuator 80 shown in FIG. 1A taken along the line labeled 1B-1B in FIG. 1A. The optical attenuator 80 includes an optical waveguide 101 disposed on a substrate or chip 100 that is configured for passing light signals between an input interface 130 and an output interface 132. The optical attenuator 80 also comprises and a surface-emitting light source chip 110 flip-bonded on top of the waveguide 101 for injecting photocarriers in the waveguide. The waveguide 101 is in the form of an elongated ridge having a top surface 101B and sidewalls 101A and extends upward from a slab medium 112. Suitable materials for the slab medium 112 and waveguide 101 include silicon (Si), silicon-germanium alloy (SiGe), gallium arsenide (GaAs), indium phosphide (InP), indium gallium arsenide (InGaAs), aluminum indium gallium arsenide (AlInGaAs), etc. A bottom-cladding layer 102 and a top cladding, which can be air as in the embodiment shown or may be other cover layers, have smaller indices of refraction than that of the waveguide medium 101 such that the signal light is confined inside the waveguide 101. As an example, the waveguide medium 101 may have a refraction index of approximately 3.5 and the bottom cladding layer 102 may have a refraction index of 1.45. In some embodiments, the bottom cladding layer 102 may also act as a reflector to reflect the portion of the direct light from the second light source 110 that the waveguide medium 101 does not absorb completely. This may be achieved by providing an interface between the medium 101 and the bottom cladding layer 102 having roughness which forms a diffuse-reflecting surface for the wavelength of the injection light.

In this embodiment, the second or injection light source chip 110 is placed upside-down on top of the waveguide 101 by flip-chip bonding technology. The second light source chip 110 may comprise one light source, an array of light sources, or a plurality of light source chips. The light source chip 110 comprises a light output aperture 111 that faces downward towards a section of the top surface 101B of the waveguide 101 with accurate alignment provided by the flip-chip bonding process. The light output aperture 111 emits the injection light downward into the waveguide 101 and the light is absorbed by the waveguide medium. The wavelength of the light emitted from the light output aperture 111 may be at, but is not limited to, wavelengths between 400 nm to 1400 nm, e.g. 633 nm, 850 nm, 980 nm, 1064 nm, etc. The optical attenuation of the light signal passing between the input interface 130 and the output interface 132 of the optical attenuator 80 may be selectively adjusted by adjusting the optical power of the second light source 110 (e.g., using a suitable controller). That is, increasing the photocarriers injected into the waveguide 101 provides increased optical absorption and thus provides increased optical attenuation of the signal light. The optical absorption of the injection light in the medium of the waveguide 101 is typically greater than 1000/cm so that it can be efficiently absorbed to generate photocarriers, while the optical absorption of the light signals in the medium of the waveguide 101 is typically less than 1/cm (i.e., transparent).

A plurality of spacers 103 are each formed by a ridge extending upward from the slab medium 112. The spacers 103 provide mechanical support and precise height control for the flipped second light source chip 110. As shown in FIG. 1B, the height of the spacers 103 is configured such that the aperture 111 does not contact the top surface 101B of the waveguide 101, but is also spaced apart from the waveguide 101 by a small distance. The distance between the bottom surface 111A of the aperture 111 and the top surface 101B of the waveguide 101 is related to the efficiency of the light entering the waveguide 101. In some embodiments, a suitable distance includes, but is not limited to, distances between 1 μm and 10 μm.

In this embodiment, a plurality of metal solder bumps 120 are included to provide strong bonding between the light source chip 110 and the attenuator chip 100 during the flip-chip bonding process. The metal solder bumps 120 also provide electrical connections between metal pads of the light source chip 110 and metal lines of the attenuator chip 100 such that electrical current may be applied from the metal lines on the attenuator chip 100 to the light source chip 110 to operate the injection light source. The optical power of the light source 110 is controlled by the selectively applied electrical energy through the metal lines.

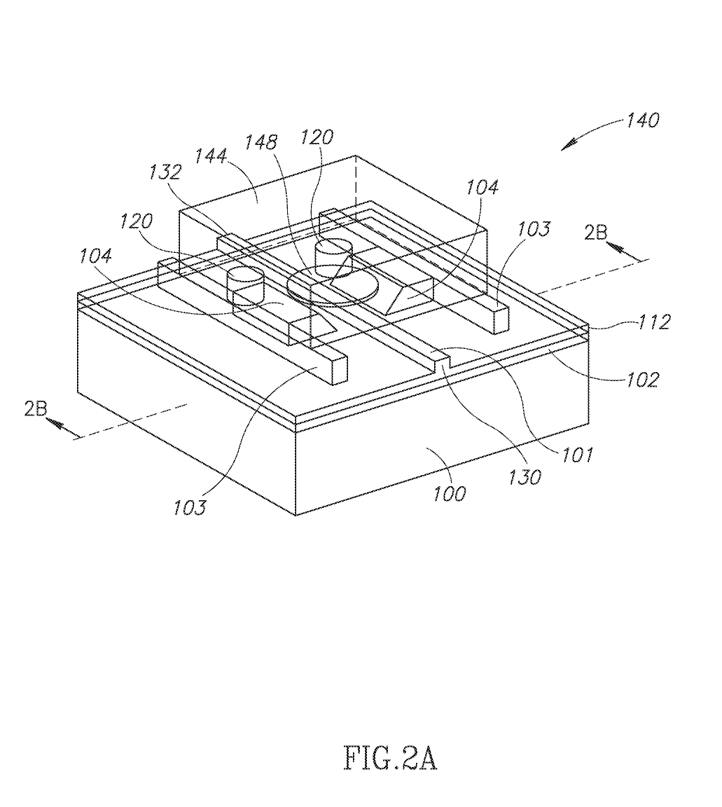

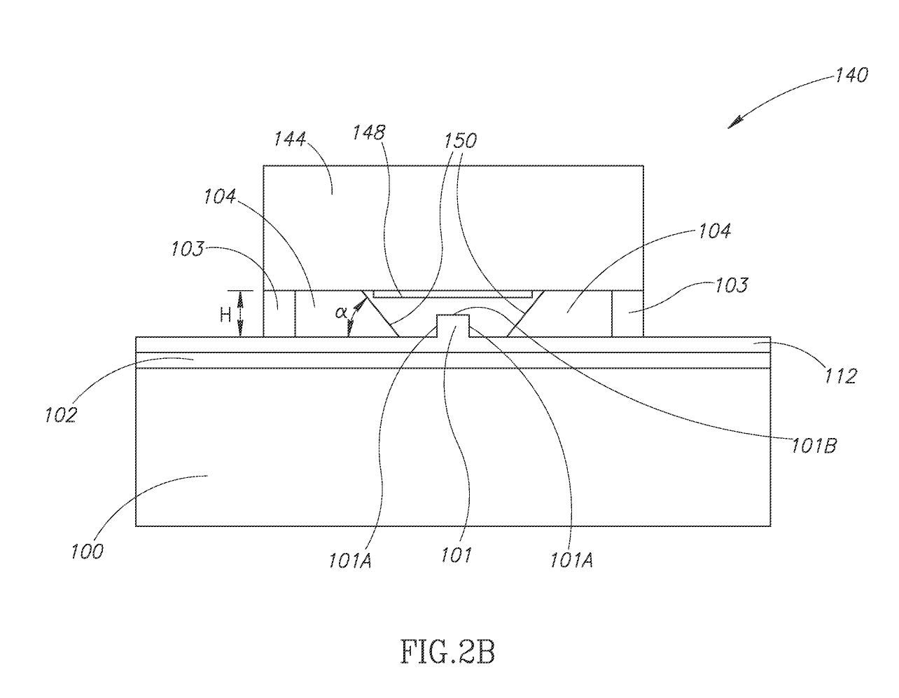

FIG. 2A is a trimetric view of another embodiment of an optical attenuator 140. FIG. 2B is a cross-sectional view of the optical attenuator 140 shown in FIG. 2A taken along the line labeled 2B-2B in FIG. 2A. In FIGS. 2A-2B and throughout the figures, like reference numerals indicate similar or corresponding parts. As shown, like the optical attenuator 80 shown in FIG. 1A, the optical attenuator 140 includes the optical waveguide 101 and a surface-emitting light source 144. In addition, the optical attenuator 140 includes angled mirror structures 104 disposed on opposite sides 101A of the elongated waveguide 101 to enhance light absorption for the light source 144 having a light output aperture 148 larger than the light output aperture 111 shown in FIG. 1A. The height H (see FIG. 2B) of each of the angled mirror structures 104 is equal to or less than the height of the spacers 103. Angled surfaces 150 of the structures 104 may be formed by anisotropic etching, micro-machining, or other suitable processes. The angle α of each of the angled surfaces 150 is designed to reflect as much light as possible emitting from the aperture 148 that does not directly enter the waveguide 101. A suitable angle for the angle a includes, but is not limited to, angles between 30 degrees and 60 degrees, etc. In some embodiments, the angled surface 150 may be covered by coating layers acting as a mirror to enhance light reflectivity. Suitable coating materials include, but are not limited to, metal and multiple dielectric layers.

The distance between each of the angled mirror structures 104 and the sidewalls 101A of the waveguide 101 is also related to the efficiency of the light reflected into the waveguide 101. A suitable distance between the angled mirror structures 104 and the waveguide 101 may be a distance that is approximately the same as the radius of the light output aperture 148. Generally, the angled mirror structures 104 are most useful when the size of the light source aperture 148 is larger than the width of the waveguide 101 between the sidewalls 101A. In this instance, a portion of the light emitted from the light source aperture 148 does not directly enter the waveguide 101. The additional mirror structures 104 operate to reflect the portion of the light to the sidewalls 101A of the waveguide 101 such that additional light is absorbed by the waveguide medium to provide greater optical attenuation.

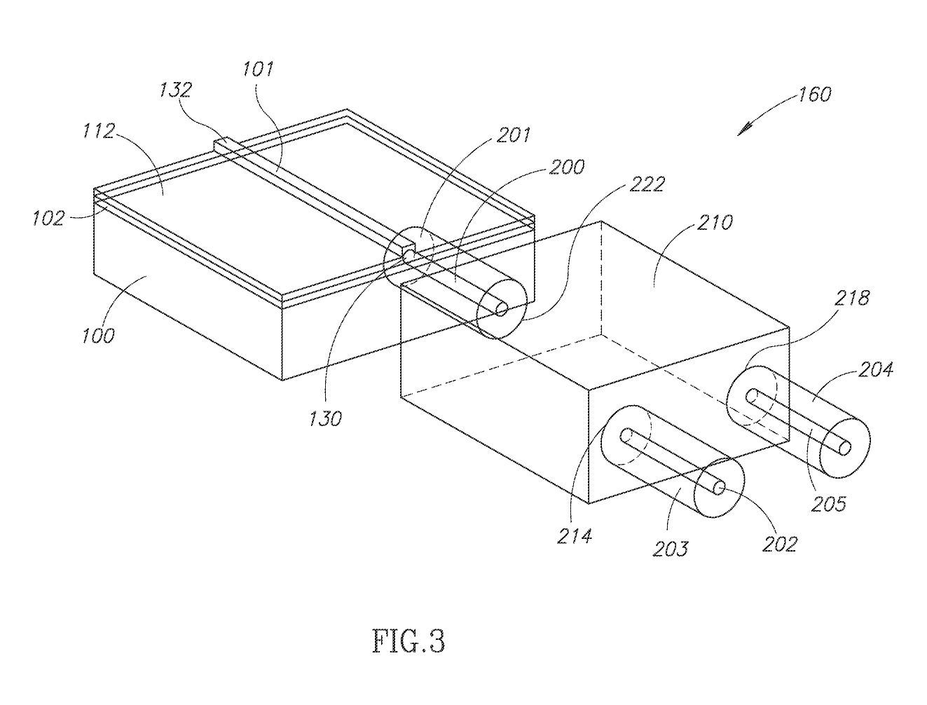

FIG. 3 is a trimetric view of another embodiment of an optical attenuator 160. In this embodiment, the optical attenuator 160 includes the optical waveguide 101 for both passing light signals and for absorbing light injected from a second light source (not shown in FIG. 3). In this embodiment, an optical fiber combiner 210 is provided that includes a first input port 214, a second input port 218, and an output port 222. A signal light may be coupled to the first input port 214 by a first input optical fiber 203 and the injection light may be coupled to the second input port 218 by a second input optical fiber 204. The output port 222 of the optical combiner 210 may be coupled to the waveguide 101 by an output optical fiber 201. The injection light and the light signals are combined in the optical combiner 210 into the output optical fiber 201 before entering the waveguide 101. More specifically, the signal light is confined in the core 202 of the first input fiber 203 and the injection light is confined in the core 205 of the second input fiber 204. The two input fibers 203 and 204 are combined through the optical fiber combiner 210 to the output fiber 201. The signal light and injection light are both confined in the core 200 of the output fiber 201 and propagate in the fiber 201. The combined light in the output fiber 201 is coupled into and propagates in the waveguide 101. The injection light is absorbed by the waveguide medium 101 to generate photocarriers, which attenuate the signal light, as discussed above. The optical attenuation of the light signal is selectively adjustable by selectively adjusting the optical power of the injection light source coupled to the second input fiber 204.

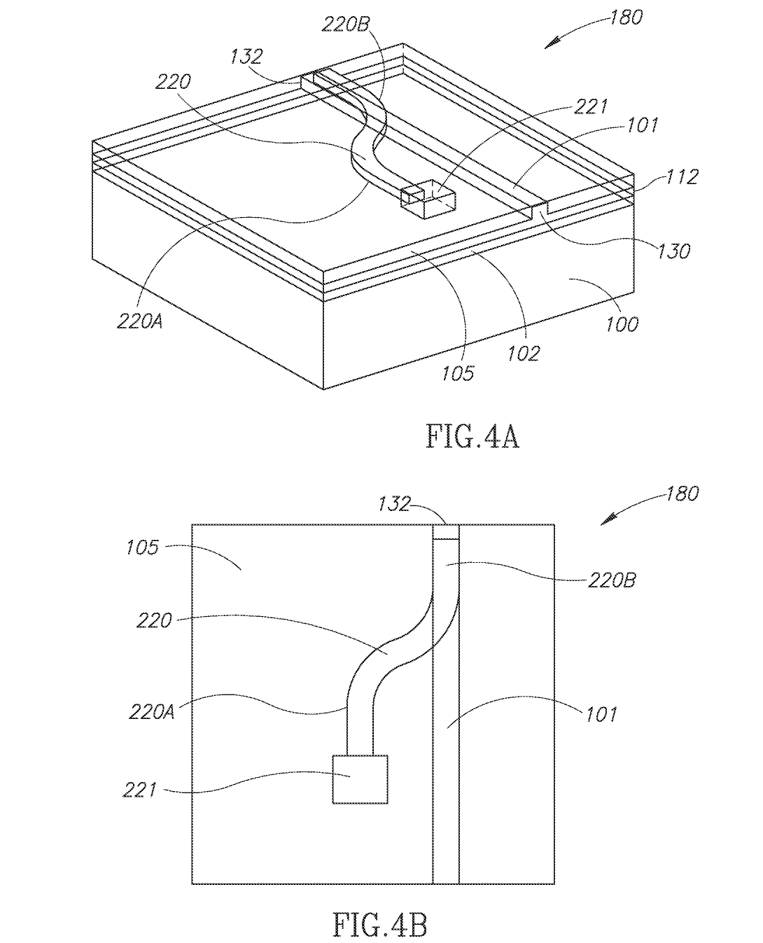

FIG. 4A is a trimetric view of another embodiment of an optical attenuator 180. FIG. 4B is a top view of the optical attenuator 180. In this embodiment, the optical attenuator 180 includes the optical waveguide 101 for passing light signals, and further includes a second, injection light waveguide 220 for passing injection light originating from a light source chip 221. As shown, the light source chip 221 is attached to the attenuator chip 100 and is coupled into the injection light waveguide 220. In the embodiment shown, the light source chip 221 is an edge emitting light source including, but not limited to, a distributed feedback (DFB) laser, a Fabry-Perot (FP) laser, a light-emitting diode, etc. The optical attenuation of the light signal passing between the input interface 130 and the output interface 132 is selectively adjustable by selectively adjusting the optical power of the second light source 221.

In some embodiments, the second or injection waveguide 220 is made of a different medium than the medium of the optical waveguide 101. In this case, the injection waveguide 220 may be made of a medium that does not absorb the injection light from the injection light source 221. As shown, a first portion 220A of the injection waveguide 220 extends from the light source 221 at a position on the attenuation chip 100 spaced apart from the optical waveguide 101. The injection waveguide 220 bends towards the first waveguide 101 that carries the light signal. The injection light is coupled or “leaked” from the injection waveguide 220 into the optical waveguide 101 when a second portion 220B of the second waveguide comes in close proximity to the first waveguide 101 for a certain distance. Suitable spacing between the two waveguides 101 and 220 at the coupling region includes, but is not limited to, from less than 1 μm to 10 μm, e.g. 0.2 μm, 0.5 μm, 1 μm, 2 μm, etc.

In the embodiment shown, the injection waveguide 220 is positioned above the waveguide 101 so that the second portion 220B is disposed directly over the waveguide 101 to couple the injection light into the waveguide 101. In this embodiment, the waveguide 101 may be covered by a layer 105 that is planarized before making the injection waveguide 220 thereon. In this case, the spacing between the two waveguides 101 and 220 is provided by the thickness of the layer 105. In other embodiments, the injection waveguide 220 may be disposed at the same horizontal level as the first waveguide 101.

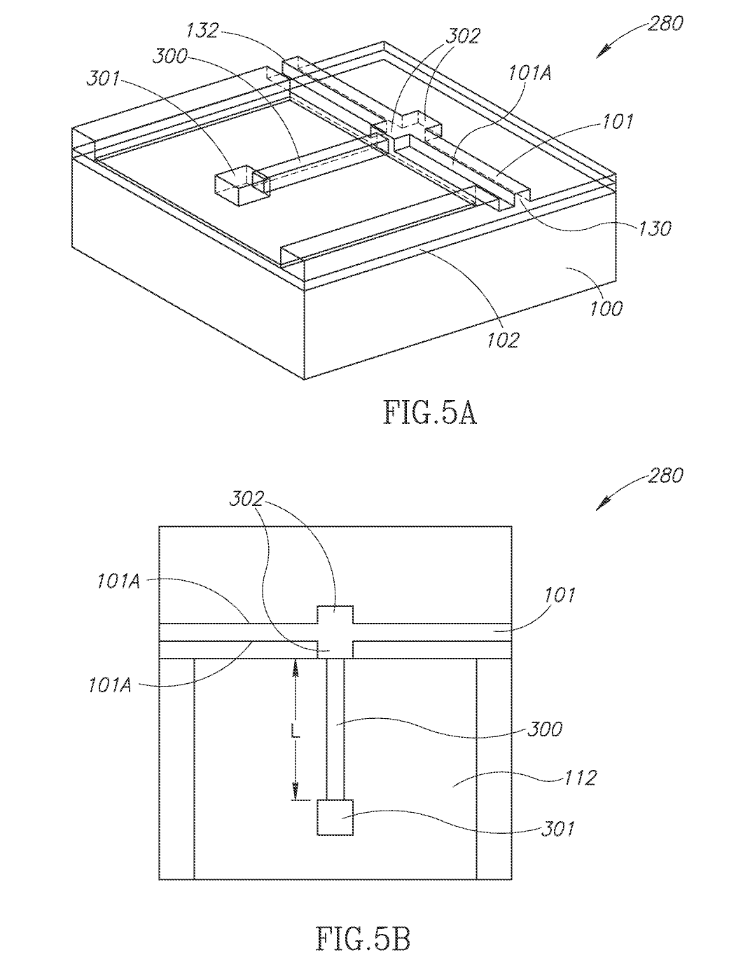

FIG. 5A is a trimetric view of another embodiment of an optical attenuator 280. FIG. 5B is a top view of the optical attenuator 280 shown in FIG. 5A. The optical attenuator 280 includes an optical waveguide 101 (or first waveguide) for passing light signals and a second or injection waveguide 300 disposed in a perpendicular relationship to the first waveguide for introducing injection light. In this embodiment, the injection light originates from a laser chip 301 that is attached to the attenuator chip 100 and is coupled into the injection light waveguide 300. As an example, the light source chip 301 may comprise an edge emitting light source including, but not limited to, a DFB laser, an FP laser, a light-emitting diode, etc.

In some embodiments, the injection waveguide 300 is made of a different medium from that of the waveguide 101. When the injection waveguide 300 is made of a medium that does not absorb the injection light, a structure 302 may be provided adjacent the waveguide 101 at the location where injection waveguide 300 would cross or “intersect” the waveguide 101. The structure 302 is wider than the width of the elongated waveguide 101 between the sidewalls 101A and extends from the opposite sidewalls of the waveguide 101. The structure 302 acts as a “connector” between the waveguide 101 and the waveguide 300 to minimize the disturbance of the light signal optical mode inside the waveguide 101 when passing the intersect region. Without the structure 302, the light signal optical mode may be disturbed by the intersecting waveguide 300 due to its different medium and dimensions. The length L of the waveguide 300 may be relatively long since the medium of the injection waveguide 300 does not absorb the injection light.

In other embodiments, the injection waveguide 300 is made of the same medium as the optical waveguide 101. In this instance, because the medium absorbs injection light, the length L of the injection waveguide 300 should not be very large. Suitable lengths for the length L of the injection waveguide 300 include, but are not limited to, lengths between 1 μm and 100 μm, etc.

Suitable materials for the substrate 100 may include silicon, indium phosphide, etc. Suitable materials for the lower cladding layer 102 may include silicon dioxide, indium gallium phosphide, etc. Suitable materials for the angled structure 104 may include silicon, indium phosphide, etc. Suitable materials for the coating on the angled surfaces 150 may include metal (e.g. aluminum, gold, etc.) and dielectric multi-layers composed of silicon dioxide, silicon nitride, aluminum oxide, etc.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

What is claimed is:

1. An optical attenuator, comprising:
a waveguide formed on a substrate that is operative to propagate an information optical signal, wherein the waveguide substantially does not optically absorb the information optical signal; and
an attenuation optical source configured to provide an attenuation optical signal into the waveguide, the attenuation optical signal having characteristics such that it is optically absorbed by the waveguide and is converted substantially into free carriers inside the waveguide to attenuate the information optical signal, wherein the amount of optical attenuation of the information optical signal is adjustable dependent on the optical power output of the attenuation optical source.

2. The optical attenuator of claim 1, wherein the waveguide is made of silicon (Si), silicon-germanium alloy (SiGe), gallium arsenide (GaAs), indium phosphide (InP), indium gallium arsenide (InGaAs), or aluminum indium gallium arsenide (AlInGaAs).

3. The optical attenuator of claim 1, wherein the waveguide comprises an elongated waveguide core portion having a rectangular-shaped or ridge-shaped cross-section, the optical attenuator further comprising a bottom cladding layer disposed on the substrate below the waveguide core portion, the bottom cladding layer having a lower optical index of refraction than the waveguide core portion.

4. The optical attenuator of claim 3, wherein the bottom cladding layer has a thickness and optical refraction index configured to substantially reflect the attenuation optical signal emitted from the attenuation optical source.

5. The optical attenuator of claim 3, wherein an interface between the waveguide core portion and the bottom cladding layer has a roughness which forms a diffuse-reflecting surface for the wavelength of the attenuation optical signal emitted from the attenuation optical source.

6. The optical attenuator of claim 1, wherein the attenuation optical source comprises one or more surface emission lasers or light emitting diodes having a light emitting facet facing toward a top surface of the waveguide.

7. The optical attenuator of claim 6, wherein the waveguide comprises an elongated waveguide core portion having a rectangular-shaped cross-section, the optical attenuator further comprising two angled surfaces formed on opposite sides of the elongated waveguide core portion, each of the two angled surfaces being configured to reflect stray light originating from the attenuation optical source into the waveguide.

8. The optical attenuator of claim 7, wherein each of the angled surfaces is disposed at between 30 degrees and 60 degrees with respect to a top surface of the substrate.

9. The optical attenuator of claim 1, wherein the wavelength of the attenuation optical signal emitted from the attenuation optical source is between 400 nm and 1,400 nm.

10. The optical attenuator of claim 1, further comprising an optical fiber combiner having a first input port, a second input port, and an output port, the optical fiber combiner being configured to combine optical signals received at the first input port and second input port and to output the combined signals at the output port, wherein the first input port is configured to receive the information optical signal and the second input port is configured to receive the attenuation optical signal from the attenuation optical source, and wherein the output port is coupled to the waveguide.

11. The optical attenuator of claim 1, wherein the waveguide is a first waveguide, the optical attenuator further comprising a second waveguide coupled to the attenuation optical source, at least a portion of the second waveguide being disposed substantially adjacent to at least a portion of the first waveguide such that the attenuation optical signal from the attenuation optical source is coupled into the first waveguide.

12. The optical attenuator of claim 11, wherein at least a portion of the second waveguide that is disposed substantially adjacent to at least a portion of the first waveguide is spaced apart from the first waveguide by a distance of 0.2 micrometers to 10 micrometers.

13. The optical attenuator of claim 11, wherein the second waveguide is disposed on the substrate at a location whereat the attenuation optical source is connected to the substrate, the second waveguide comprising a first portion spaced apart from the first waveguide and a second portion substantially adjacent to the first waveguide.

14. The optical attenuator of claim 11, wherein one of the first waveguide and the second waveguide is disposed above the other of the first waveguide and the second waveguide at a location whereat at least a portion of the second waveguide is disposed substantially adjacent to at least a portion of the first waveguide.

15. The optical attenuator of claim 11, wherein the first waveguide and the second waveguide are disposed in the same horizontal plane at a location whereat at least a portion of the second waveguide is disposed substantially adjacent to at least a portion of the first waveguide.

16. The optical attenuator of claim 1, wherein the waveguide is a first waveguide, the optical attenuator further comprising a second waveguide having a first end coupled to the attenuation optical source and a second end opposite the first end facing perpendicular to the first waveguide, the second waveguide being formed from the same material as the first waveguide and having a length extending in a direction perpendicular to the first waveguide of between 1 micrometer and 100 micrometers.

17. The optical attenuator of claim 1, wherein the waveguide is a first waveguide, the optical attenuator further comprising a second waveguide having a first end coupled to the attenuation optical source and a second end opposite the first end facing perpendicular to the first waveguide, the second waveguide being formed from a material that substantially does not absorb the attenuation optical signal.

18. The optical attenuator of claim 17, wherein the first waveguide comprises an elongated waveguide core portion having a rectangular-shaped cross-section, the optical attenuator further comprising a connector structure extending outwardly on opposing sides of the waveguide core portion, the connector structure being configured to couple the first waveguide and the second waveguide together.

19. The optical attenuator of claim 1, further comprising a controller coupled to the attenuation optical source that is operative to selectively adjust the power output of the attenuation optical source.

20. The optical attenuator of claim 1, wherein the waveguide comprises an elongated ridge extending upward from the substrate.

21. The optical attenuator of claim 1, wherein the attenuation optical source comprises a laser, a light emitting diode, or a thermal emitter.

22. The optical attenuator of claim 1, wherein the attenuation optical source comprises a chip that is flip-bonded to the substrate.

23. The optical attenuator of claim 22, wherein the attenuation optical source is positioned at a distance of between 1 micrometer and 10 micrometers from the top surface of the waveguide.

24. An optical attenuator, comprising:
a first waveguide formed as an elongated ridge extending upward from a slab on a substrate, the first waveguide being operative to propagate an information optical signal without optically absorbing the information optical signal; and
an attenuation optical source coupled to the first waveguide and configured to provide an attenuation optical signal into the first waveguide, the attenuation optical signal having characteristics such that it is optically absorbed by the first waveguide and is converted substantially into free carriers inside the first waveguide to attenuate the information optical signal.

25. The optical attenuator of claim 24, further comprising a second waveguide have a first portion coupled to the attenuation optical source and a second portion coupled to the first waveguide.

26. A method for attenuating an optical signal, comprising:
providing a waveguide formed on a substrate that is operative to propagate an information optical signal, wherein the waveguide substantially does not optically absorb the information optical signal; and
injecting an attenuation optical signal from an attenuation optical source into the waveguide, wherein the attenuation optical signal has characteristics such that it is optically absorbed by the waveguide and is converted substantially into free carriers inside the waveguide to attenuate the information optical signal.

27. The method of claim 26, further comprising selectively adjusting the optical power output of the attenuation optical source to adjust the attenuation of the information optical signal.

28. The method of claim 26, wherein the waveguide is made of silicon (Si), silicon-germanium alloy (SiGe), gallium arsenide (GaAs), indium phosphide (InP), indium gallium arsenide (InGaAs), or aluminum indium gallium arsenide (AlInGaAs).

29. The method of claim 26, wherein the attenuation optical source comprises one or more surface emission lasers or light emitting diodes having a light emitting facet facing toward a top surface of the waveguide.

30. The method of claim 26, further comprising combining the information optical signal and the attenuation optical signal and directing the combined optical signal into the waveguide.

31. A method for producing an optical attenuator, the method comprising:
providing a substrate;
producing a first waveguide on the substrate that is operative to propagate an information optical signal, wherein the first waveguide substantially does not optically absorb the information optical signal;
providing an attenuation optical source; and
optically coupling the attenuation optical source with the first waveguide, the attenuation optical source being configured to provide an attenuation optical signal into the first waveguide, the attenuation optical signal having characteristics such that it is optically absorbed by the first waveguide and is converted substantially into free carriers inside the first waveguide to attenuate the information optical signal, wherein the amount of optical attenuation of the information optical signal is adjustable dependent on the optical power output of the attenuation optical source.

32. The method of claim 31, wherein optically coupling the attenuation optical source with the first waveguide comprises bonding the attenuation optical source to the substrate using a flip-chip bonding process.

33. The method of claim 31, wherein optically coupling comprises producing a second waveguide optically coupled to the attenuation optical source and the first waveguide.

34. The method of claim 33, wherein producing the second waveguide comprises covering the first waveguide with a spacing layer, planarizing the spacing layer, and producing the second waveguide over the planarized spacing layer.

35. The method of claim 31, further comprising producing a reflecting structure disposed proximate to the first waveguide having an angled surface configured to reflect light from the attenuation optical source into the first waveguide.

36. The method of claim 35, further comprising applying a reflective coating layer on the angled surface of the reflecting structure.

37. The method of claim 35, wherein the reflecting structure is formed by at least one of an anisotropic etching process and a micro machining process.
